(19) United States
(12) Patent Application Publication
(10) Pub. No.: US 2011/0015953 A1
(43) Pub. Date: Jan. 20, 2011

(54) Method of providing children's restraint devices at consolidated car rental facilities and public carrier terminals

(76) Inventor: Deborah M. Maunus, Palm City, FL (US)

Correspondence Address: Deborah M. Maunus, 1550 SW St Andrews Drive, Palm City, FL, 34990, US

(21) Appl. No.: 12/804,148

(22) Filed: Jul. 15, 2010

Related U.S. Application Data
(60) Provisional application No. 61/270,919, filed on Jul. 15, 2009.

(51) Int. Cl. G06Q 10/00; G06Q 30/00

(52) U.S. Cl. 705/5

(57) ABSTRACT

A system and method are presented for providing a service to travelers to enable them to acquire, at one's destination, essential items that may be checked or carried on an aircraft or available at an alternative mode of transportation, such items including child restraint devices for use in cars, mobility assistance devices. A consumer may initiate a rental of the child's restraint device through either an operating company's website, a car leasing or rental company's website, airline website that would furnish a link to the operating company's site, or at the point of purchase. Upon initiating a reservation, the consumer would initiate data file containing reservation to the operating company's website. The method is responsive to the needs of travelers, airlines, airports, and other public carriers including trains, rental car companies, buses, and cruise ships for providing the consumer convenience, efficiency, reliability and high standard of hygienic inventory in the rental or purchase of children's restraint devices at either the baggage area within an airport terminal, at the car rental companies within the terminal or outside the airport, at CONRACs, or in any nearby area.

### CROSS-REFERENCE TO RELATED APPLICATIONS

This application claims the benefit of PPA Ser. No. 61/270,919 filed 2009 Jul. 15 by the present inventor, which is incorporated by reference.

### BACKGROUND OF THE INVENTION

1. Area of the Invention

The invention relates to a method of providing a service to travelers enabling them to acquire, at their destination, essential items that would typically be checked or carried on an aircraft or alternative mode of transportation, such items include child restraint devices required for use in cars and mobility assistance devices.

2. Description of Related Art

In the United States there are approximately 1.8 million airline passengers per day which, in aggregate, account for over 4 million pieces of checked baggage or luggage. In addition, substantial numbers of people travel via alternative modes of transportation including, without limitation, rental cars, trains, buses, cruise ships and by private means including personal vehicles, limousines and private planes.

At present, the number of passengers is decreasing while expenses incurred by airlines, airports and rental car companies are increasing. This is an industry-wide issue with regard to all airlines and airports, whether public or private. The airline industry is at a critical juncture in confronting challenges of limiting decreases in levels of service to passengers while air fares, and additional charges are increasing due, among other factors, to increasing fees imposed for checked baggage and/or luggage. Economic conditions mandate it is imperative that airports and airlines decrease their reliance on traditional airline based revenues, compensate for lost and decreasing concession revenue, and develop alternative revenue sources immediately and going forward as the economy recovers. Airports and airlines alike seek innovative solutions to present conditions and are striving to reduce overhead including labor and jet fuel costs which are severely impacted by checked and carry-on luggage and/or baggage, that in accordance with the system and method set forth herein, may be provided at the traveler's destination. Results thereof are obvious benefits of enhanced compliance with legal requirements in the area of children's restraint devices, availability at the destination point of medically necessary equipment, and the reduction in environmentally adverse levels of carbon emissions, aspects of which are subject to present and pending legislation. In regard to the issue of children's restraint devices, at present, car rental companies are not efficiently managing the rental operation thereof due to various factors inclusive of significant industry-wide reductions in force coupled with the necessity to reduce overhead and extend the life of current inventory, which have occurred throughout the car rental company sector

It has been established that car rental concession revenue accounts for approximately 40% of all airport revenue and that 41% of passengers departing from an aircraft make use of a rental car. Among demographic-relevant passengers renting a car, a mere 22% of passengers rent car seats, 61% of passengers bring their own car seats, and 17% do not plan on utilizing a car seat, this representing a violation in applicable state laws. These figures contribute to additional overhead, expenses and jet fuel consumption and are subject to baggage and or luggage fees. The statistics were reported prior to airlines' imposition of checked baggage fees.

As used herein the term CONRAC is used as an acronym for “Consolidated Rental Car Facility,” and is used in the context of rental car companies located at, near or controlled by airports. CONRACs may assume different configurations at different airports, however, in general a CONRAC will include all rental car company facilities and their associated operations, including customer service, administrative offices, ready return parking, fueling and maintenance facilities located upon airport property or upon property otherwise controlled by the airport, and may be incorporated into parking structures or areas. By centralizing all car rental operations adjacent to the Airport, CONRAC eliminates the need for rental agency shuttle buses and dramatically reduces the number of rental cars on terminal roadways. This is designed to help minimize the Airport's carbon footprint by improving overall traffic flow around the passenger terminal. Inclusive in a CONRAC may be rental car counters or alternative forms of representation or signage located at the baggage claim level of the terminal proper. Most commonly, the baggage claim area of an airport terminal is connected by either minibus, van, tram or moving walkway or automated people mover (APM) to larger off-terminal parts of the airport at which the respective rental car companies are usually located, individually or in group by brand. At present, the trend, as exemplified by Hartsfield International Airport, Atlanta Ga., slated for opening November 2009, is that of consolidation of respective rental car companies into a single building or complex, i.e., a CONRAC. It is understood that the inventive method may be practiced at such CONRAC or at airports in which one or more rental car companies are not consolidated into a common rental car facility and at, typically, smaller airports having a rental car presence primarily in form of counters on the baggage claim level in which the cars to be rented are typically within a short walking distance of the terminal itself. The present method is also applicable to persons requiring assistance devices, whether child or medical related, at airports or at alternative mode of transportation terminals, whether or not with reference to the rental of an automobile, in which case the present invention would typically be practiced through the use of a kiosk, a Retail Management Unit (RMU), in-line space or the like, located in the vicinity of the baggage claim location.

The decreasing number of airline travelers which now rent cars may have little effect upon the number of passengers requiring such assistance devices and, in fact, as state laws continue to more vigorously enforce child restraint requirements, the need for non-renters of automobiles at airports and alternate mode transportation terminals, may in fact increase over time. The most rapidly growing segments of the US population are children and the elderly who require child restraint devices and medical assistance devices respectively. These changes in market and legal conditions present an opportunity which the present invention seeks to address.

One source of difficult-to-handle bulky baggage, from both the perspective of the traveler and the airline, is that of children's restraint devices, more specifically infant restraint, front facing, rear facing, and booster seats. As such, the term child seat is used herein is to be understood to include all forms of child restraint devices, and others that may be developed or become required in the future. With this in mind, it is known that more than 20 million parents travel annually with children and that, depending upon the airline and not currently subject to FAA regulation, the car seat may or may not be classified as checked baggage and may or may not be subject to additional fees, dependent upon the individual airline. There is in fact no standard in this area. Depending upon various factors, an airline may, at a given time, require that a passenger check only baggage, exclusive of a child restraint or required assistance device, this typically as revenue driven and a function of the capacity of the particular flight. In other words, what may be checkable as baggage, or even carry-on, on a given flight may not be so checkable upon the next flight of the same airline or of a different airline using the same aircraft. This circumstance has confused and angered many passengers, and contributed to increase the risk of damage to child restraint device in the course of transit since, as is well known, checked baggage is often subject to damage. Baggage and/or luggage which passengers attempt to carry on board which is gate checked or reclassified as checked bagged face an increased risk of damage.

Further, the quantum of lost, damaged or delayed baggage continues to increase and may leave one without essential apparatus required by a child or an assistance device required by a different traveler. Approximately 2% of passengers report luggage related problems. There is a need for a method and system to reduce the amount of luggage. As a result, the safety of the traveler, after arrival at destination, may be in jeopardy. Many states in the U.S. require car rental companies to offer this child restraint rental service, yet availability or condition of the inventory is not monitored or regulated. In addition, upon arrival at a destination, most rental car companies do not guarantee car seat availability and may not, in any event, have available at a given location for rental the appropriate size for the child. The renting of a child's restraint device is not an area of core competence of rental car companies. There is presently no seat management system like inventive method to monitor the seat rental operation. Car rental companies currently are free to rent damaged recalled, expired, or medically contaminated inventory, jeopardizing the passenger safety and do so regularly. There is a growing public awareness of this issue.

In addressing the above, the inventive method recognizes long-term efficiencies which would result from the outsourcing or co-venturing of this service as a cost reduction strategy, an important convenience to customers, and a public safety, and relations benefit.

Further, airlines can realize a substantial savings, both hard and soft costs, through the reduction of cargo weight. For example, a reduction of 50 pounds per annum in each of fifty Boeing 737 airplanes having an average fuel expense of $3.50 per gallon would net a savings per annum of $1.35 million to the airline and a reduction of 290 pounds of carbon dioxide emission annually to the environment. In addition to responding to carbon emission limitations as imposed by both existing and imposed legislation, airlines can realize a reduction in labor expense in the cargo function, and wear-and-tear on the aircraft through reduction in cargo load; or may accommodate additional conventional luggage, cargo freight (an additional revenue source), or realize significant fuel savings. The reduction in baggage volume will reduce the absolute amount and value of baggage lost, damaged or delayed and, therein, will reduce liability for lost and damaged baggage, result in a reduction in congestion at luggage locations, and increase efficiency in turnaround time of the aircraft.

At present, national car seat manufacturers sell millions of car seats, however outside of the context of the airline or car rental industry. Although locations of the various major car rental companies offer the rental of children restraint devices, if they are available, there does not exist a method or system adapted for the provision of such critical equipment to customers of car rental companies with the efficiency and cost-effectiveness and other distinctive aspects of the car seat management system.

The present invention is not limited simply to airline passengers wishing to rent children's restraint device; but, as well, is applicable to broad categories of travelers inclusive of those travelling by train, bus or cruise ship in which a variety of needs are presented to the traveler, and common carrier, and agent. For example, travelers are apt to forget essential items in their luggage when packing. That is, certain items to be packed may not be conducive to travel as they may tend to spill, explode, spoil or be otherwise banned by the Transit Security Agency. Certain items to be packed must, to be practical, be bought in travel sizes, e.g., travel irons that are inconvenient to use. Further, business travelers may be required to travel on short to notice, and therefore they prefer to leave for the airport or train by car, from their offices, enabling them to travel directly to a terminal without going home to pack luggage. Other travelers may find it physically or logistically difficult to carry even a minimum of luggage or impossible to carry luggage altogether and yet, further, may require additional luggage due to the need for medical equipment and medications. Yet other travelers may wish to avoid traveling with expensive items such as laptop computers or jewelry that may pose a risk of being stolen—or not safe to travel with, e.g., a target for mugging or crime.

In another category, travelers to a climate which is very different from where they live may be forced to acquire clothing that they will need only while staying at that destination, such as one traveling from a hotter humid climate to one that is cold. Therein winter clothing acquired for travel may be bulky, cumbersome and require additional pieces of luggage. One application of the present inventive method and system is therefore to enable such type of travelers to rent what may be needed only for the time of a stay in a different climatic zone. This will of course be of interest to travelers not wanting to buy items that only be used for the brief period of time of their trip or vacation and to then ship them home. Such factor is exacerbated in that items suitable for the destination may simply not be available at the time of origin or, minimally, not available at the time of travel, or merchants may wish to use their selling space for more seasonally appropriate items.

In regard to the state of the art in connection with the delivery aspect or attribute area, U.S. Pat. No. 7,219,074 (2007) to Capek et al, entitled System and Method for Obtaining Items at a Traveler's Destination, teaches, in generic terms, that is it advisable to provide, as a service to a traveler, items that may be needed at a destination to avoid the need to carry the same as luggage upon a common carrier. The teaching of Capek however is both generic to all forms of transportation and to all forms of luggage and encompassed many limitations which are not present in the present inventive method. These include the absence of a network of participating suppliers and multiple deliveries to the traveler at a destination point; a requirement for an advanced consumer specific reservation, data or the like. The present seat management system, unlike Capek, does not require that a database be maintained of a user's medical, personal or other needs or preferences. The invention also does not require particular delivery or coordination of any type at the traveler's destination. In the invention, there is no need for the use of multiple suppliers that must, in Capek, be coordinated at a particular destination, such as an airport, railroad station, hotel, private home or the like. As such, the seat management system reuses inventory designed to increase use and efficiently manage car seat rental operation. Capek provides no system to monitor recalled or retired inventory and does not provide a sanitation and disinfection cleaning protocol. Further, in the present invention, there is no requirement of interfacing, coordination or the like of multiple parties once a reservation has been made.

There also exists in the art websites, the business of which is to provide rental of various types of goods to travelers, however in all cases the commodity must either be scheduled in advance and delivered to the customer subject to a non-refundable delivery fee, typically to a hotel, or the customer must travel to an acceptance center which essentially is a network of rental stores. Such a system is also taught in Japan Patent No. 2002056318A to Nippon Electric Company.

Regarding websites, as are known to the inventor, the site, supported by a company known as Wee Travel Inc. offers the rental of “highest rated brands of infant and child's seats, folding cribs, strollers, high chairs, . . . ” and other items of interest to children such as baby toys. Wee Travel offers pick-up or delivery to airports, hotels, residences and businesses, in various cities in Canada. In the context of baby or child restraint devices, the products of Wee Travel cannot be purchased or reserved through an airline, car rental or third-party (e.g., Expedia) website or obtained, if desired, at an airline baggage or CONRAC requiring exclusive reservation through the Wee Travel website.

The lack of inventory standardization and compliance with sanitation protocol erodes consumer confidence and contributes to a low rate of car seat usage in rental cars and other modes of transportation.

The present inventive car seat management system responds to the above long felt needs in the art.

### SUMMARY OF THE INVENTION

The present inventive method and system is responsive to the needs of travelers, airlines, airports, and other public carriers including rental cars trains, buses, and cruise ships for providing to the consumer convenience, efficiency, reliability and a high level of cleanliness of rented or purchased children's restraints and mobility assistance devices. This occurs at either the baggage area within an airport terminal, at the car rental companies located either inside or outside the terminal, at CONRACs, or in any nearby area where the passenger has elected to rent a car from a car leasing entity. A consumer may initiate a rental of the child's car seat, restraint or mobility assistance device through either the operating company's website, the car leasing/rental company's website, or any other third-party site or operator or the airline website that would furnish a link to the operating company's site.

The reservation process will most commonly initiate through a customer's login directly onto the web site of the rental car agency. The transaction is processed and a data file containing the transaction is sent directly to the operating company.

Relationships between the airlines and car rental companies are contemplated whereby, if a consumer initiates making an airline reservation, the consumer may directly link to the operating company's website. A link may be generated or activated via built-in triggers if the consumer checks a demographic box indicating a “child's ticket” or if more than two (2) tickets are purchased in the same transaction in which the site user is asked whether or not a child's restraint is required upon destination. A similar question would be asked in the case of the “special needs” box associated with an airline or car rental company website if, for example, a wheelchair, walker or other assistance device is required by the passenger. The customer may also either log onto the operating company's website or telephone directly to the operating company's computer system or any other third party source to obtain a confirmation code of the rental for input at the distribution site, thus providing point of operation efficiencies, and cost-effectiveness. In the event a car rental customer has not processed the transaction directly by the car rental company, following verifying input a rental confirmation number for use by the system is issued which contains all necessary operational data, as set forth below.

Preferably, the method is practiced at CONRACs where all rental companies are under one roof, off-site of the terminal but part of the airport.

It is accordingly an object of the invention to provide a link between applicable consumers, airlines, car rental companies, third party websites, and entities including travel agents, to incorporate a car seat rental transaction into a reservation process.

It is another object to provide the present method to a consumer in either a centrally located kiosk, a Retail Management Unit (RMU), in-line space in the baggage area, in a car rental company within or near the airport, or in a CONRAC of an airport.

It is a further object to provide inventory control of rented products through the use of RFID chip technology using an optical reader or UPC bar code to identify and control inventory distribution and service and to manage recalled and/or expired inventory, through use of GPRS devices.

It is another object of the invention to provide child restraint devices, items for handicapped persons of the like, and other travel or climate-related products through the use of a centralized airport-proximate warehouse in which all articles are inspected for damage, sanitized and/or disinfected as needed and reviewed for compliance with federal safety standards.

It is yet another object to increase child safety by providing high quality, safety-inspected, sanitized and disinfected child restraint devices.

It is a further object to provide a system by which airlines can reduce fuel costs, carbon emissions, reduce labor expenses, reduce liability, and enhance profitability of use of freight cargo space.

It is a yet further object to effectively manage retired and recalled inventory.

Another object is to provide a method by which the incidence of lost or damaged checked baggage and resulting liability (the expense of which is passed on to the consumer) to airline and inconvenience to passengers may be reduced.

It is a further object to provide a method by which charges for extra and excess baggage may be minimized.

It is a yet further object of the invention to provide a means by which an airport may capture additional concession revenues.

It is another object to provide a system by which a more cost-effective use of CONRAC and rental car areas, both inside and outside airports, may be effected.

It is a further object of the invention to enhance compliance with state specific guidelines and other laws requiring that children utilize restraint devices in cars and all modes of transportation.

It is a yet further object to provide a service to travelers to acquire at the traveler's destination site items normally packed in or with the travelers' luggage to secure rental, purchase or delivery of the items at or near a public carrier destination point.

It is still another object of the invention to provide child restraint and assistance devices at alternative mode of transportation terminals, whether or not with reference to the rental of an automobile.

It is a still further object to provide a system of the above type to enable a traveler to acquire at his destination items typically packed in or with baggage of various types.

It is another aspect of the inventive system to provide a method and system for providing specialized service for travelers in need of assistance devices, and to aid in the selection and renting of selectable items.

The above and yet other objects and advantages of the present invention will become apparent from the hereinafter set forth Brief Description of the Drawings and Detailed Description of the Invention.

### BRIEF DESCRIPTION OF THE DRAWINGS

FIG. 1 is a conceptual view of the relationship of the mobile GPRS device and the workstation of a user.

FIG. 2 is a conceptual view of internal and external hardware associated with the system.

FIG. 3 is an enlarged view of a homepage of the GPRS hand-held device, displaying a single account record.

FIG. 4 is a view similar to FIG. 3, but showing restraint device “pick-up” information for a given car company location.

FIG. 5 is of a screen of the hand-held device showing all car seats linked to a reservation number.

FIG. 6 shows a return status of multiple records on the hand-held device.

FIG. 7 shows a PC screen as it might appear at a workstation shown in FIG. 1.

### DETAILED DESCRIPTION OF THE INVENTION

The inventive method and system practiced by an operating company is intended to provide a vital consumer, airline and car rental agency function that will incorporate a customer's child's car seat/restraint device or device for use by the handicapped or any passenger requiring an assistance device, for rental as a part of the reservation process. This reservation process will most commonly initiate through the website of the rental car agency, either by means of the customer's direct logging into that site or, if the customer first logged onto an airline or any other third party site reservation page, an Internet link between the airline reservation site and the operating company will exist by virtue of a customer having caused a child or special need related reservation trigger. A trigger could also be based on demographic criteria such as age.

Upon completion of a drop-down menu a traveler/system user will indicate the type of car seat/child's restraint device required or preferred, i.e., infant car seat, forward, or rear facing child seat or booster, alternatively, types of handicapped/geriatric equipment of interest, e.g., wheelchair, walker, scooter, or the like.

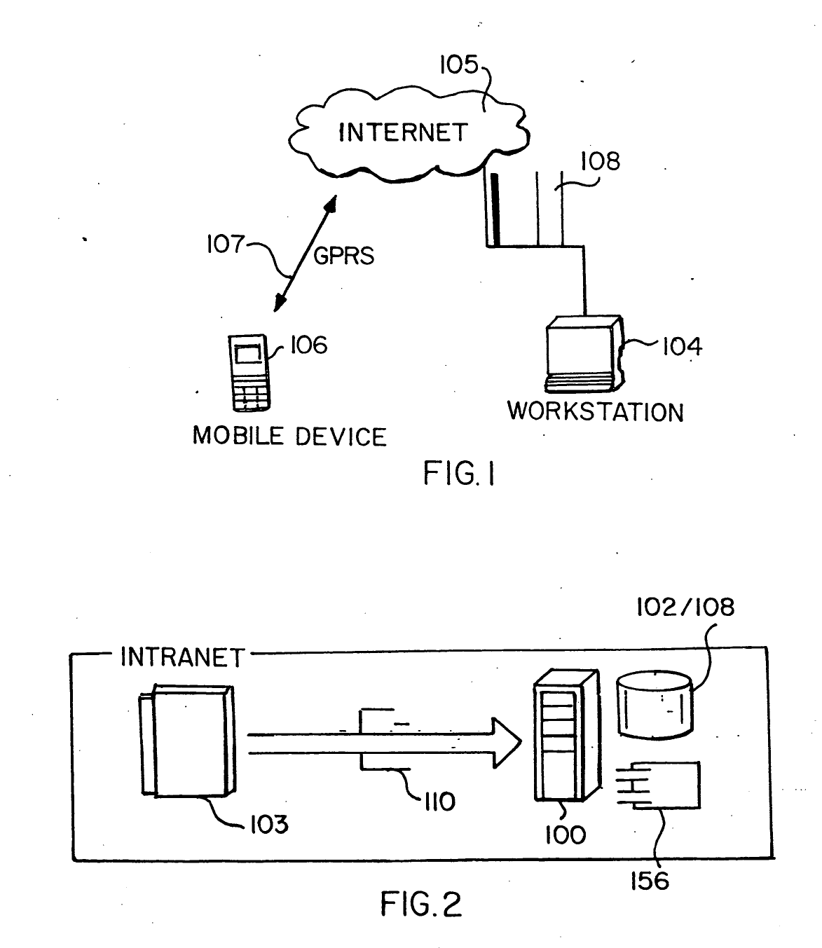

Generically, the operating company's computer system (see FIG. 1) inclusive of enabling software and PC based hardware, enables management in execution of financial transactions between participating entities which, typically, will take the form of an outsourcing arrangement between the operating company and the respective car rental agencies and/or third party operators, e.g., travel web sites, travel agents, promotion codes. Applicable financial transactions will include debiting and crediting of credit card charges, and refunds or rebates for customers as applicable. Also included will be collection of deposits, electronic signature upon waivers of liability to the extent legally permissible, and a webpage indicating responsibility for loss, theft, or damage of the rented product.

Where the inventive method is practiced as an outsourcing relationship with a rental car entity, the company will either occupy a trailer facility within a location of the rental car entity; provide centralized staging areas within multiple car rental companies, within or external to a CONRAC; and may present a counter-front staging of its inventory in both the regular and the preferred customer counter areas of the car rental entity. This “staging function” includes everything that happens in a CONRAC or non-CONRAC location pursuant to the present method and may take the form of a proprietary retail management unit (RMU), such a kiosk, particularly designed to secure and provide children's car seat, for use by travelers not renting a car or in lieu of the “staging function” in smaller airports. Such RMUs will be capable of wireless communication with the operating company so that the number of rented versus, at any time, unrented number of car seats at a car rental agency or in the RMU itself, can be electronically inventoried in a multi-product seat management system, per FIG. 2 (more full described below), provided by the operating company individually or as a service to the rental car entity to permit it to efficiently manage the usage and ascertain the status of car seats at a given car rental location.

The present system provides transparency and accountability for the seats, aging thereof, comments regarding condition thereof, and monitors recalls and consumer alerts. It is scalable for operation of car rental locations throughout the country, both CONRAC and non-CONRAC in character.

In a preferred embodiment, customers of the rental company as well as travel agents, may process all transactions within the reservation system of the car rental organization. (See FIG. 2.) Such system also would be triggered upon a customer's selection of “extras”, or a similar trigger during the reservation process. The export of data to and from the operating company would be seamless to the customer.

As more fully set forth below, data used by the present system includes:

1. Transaction source, e.g., airline, car rental company, Internet, phone, third party such as travel agent or travel website.

2. Reservation number.

3. Reservation type, e.g., standard versus a preferred category of renter or a frequent flyer.

4. Customer first and last name.

5. Rental location.

6. Return location.

7. Reservation date and time.

8. Return date and time.

9. Changes in reservation status.

10. Operating company inventory type, e.g., infant, seat front-facing, rear-facing, or booster.

In a preferred embodiment, the operating company will not process financial transactions, collect payments from customers, or have direct access to the rental agency database. Rather, the operating system creates a data file from the car agency reservation system and forwards it to a folder on a dedicated server or a server having space dedicated to the operating company's software which automatically imports data into the operating company's database in the information categories set forth above. See FIGS. 1 and 2. Therein, a PC based application (see FIG. 1) is used through the Internet 105 to access information about the rental status of any car seats including inventory age and recall notices. The system tracks multiple parameters of interest inclusive of reservation numbers, seat availability and consumer usage patterns. A market research database 102 is then created.

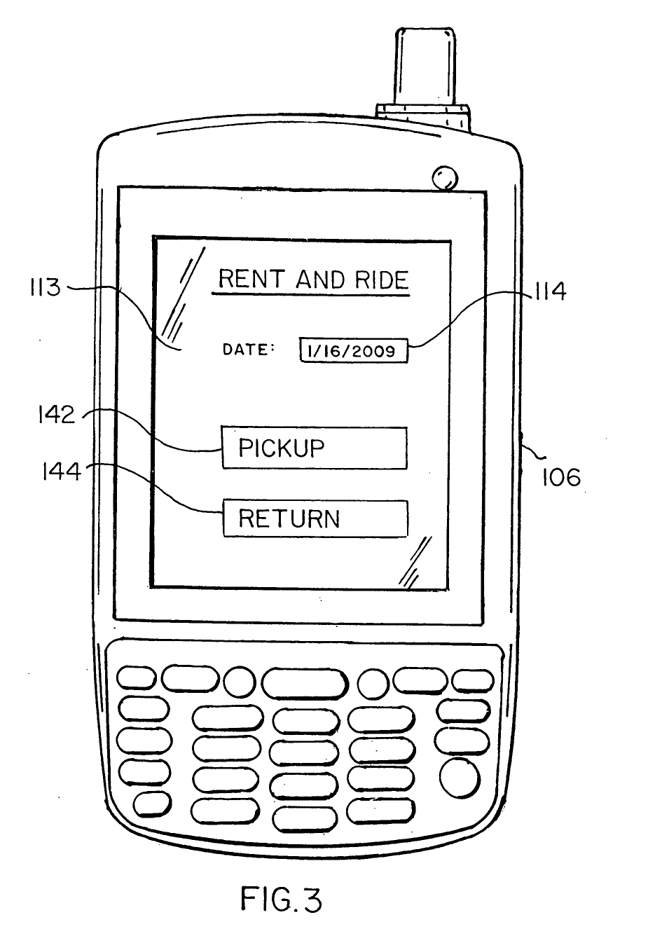

With reference to FIG. 1, the inventive method and system further includes a mobile application for access to the Internet using GPRS (global positioning reservation system) 107, a wireless network 105, and a mobile bar code scanning device 106, more fully discussed below. This mobile application allows operating company users to bar code scan the car seats and the like to update the status at the back end database system 108 while updating the PC application in real time. See FIGS. 3-6.

The advantages of the car seat management system to the car rental entity include the following:

1. Cost reduction strategy inclusive of reduction of hard costs inclusive of labor expense, inventory and liability expense; and soft costs inclusive of improved operational efficiencies; RFID (radio frequency identification); promotional offers and opportunities; supply chain visibility; and electronic distribution of inventory

2. Public relations. Establish a car rental entity as child/handicapped/elderly friendly car rental company having enhanced public safety appeal, assuring compliance with local legislation, and affording an opportunity to donate inventory, after a period of use, to a community charity.

3. Improved customer service in the form of:
1. Guaranteed availability.
2. Guaranteed hospital-grade sanitation.
3. Offer of optional sanitary covers.
4. Inventory standardization.
5. Customer retention, enhanced service and opportunity for the customer to purchase the leased product.
6. Convenience.
7. Solution to checked baggage fee for child car seat/restraints.
8. Growing of the brand name of the car rental agency through:
   (a) increased revenue from their existing facilities.
   (b) capture of unrealized revenue.
   (c) more aggressive marketing and PR campaigns.

The operating company will enter into a revenue sharing agreement with respective car rental companies upon calculations based upon revenue produced by the inventive method and system, upon a basis to be determined.

In the case of airports not having a CONRAC, counter-front staging by the operating company may still occur at the car rental companies within the terminal, or delivery of the child restraints may be delivered to the consumer through a kiosk in the terminal or baggage area or by a proprietary retail management unit (RMU). As such, in the case of smaller airports, a single kiosk in the terminal area may be employed to service all car rental agencies participating in the program with the operating company as well as with anyone wishing to rent a child restraint or assistance category product that is not renting a car as well.

Upon completion of the rental period, most car seats are returned to the airport of arrival. The operating company may utilize a centralized facility, for the staging and loading of seats in the case of smaller airports as above described, or utilize a trailer facility or centralized staging area for each respective rental car agency location at non-CONRAC larger airports, e.g., Newark and Phoenix. Whether at a centralized warehouse, at a trailer facility, or a combination of both, all rented car seats and the like are inspected upon their return and during a service cycle for damage, are sanitized and reviewed for compliance with safety standards including those of the Consumer Safety Commission and the Juvenile Product Manufacturers Association. Applicable inspection will occur for all inventory used in operations.

As an integral aspect of the above, the operating company preferably enjoys a special marketing relationship with a leading manufacturer of children's restraint devices who supplies the rental inventory to the operating company. Inventory tracking, storage and distribution, prior to reaching the premises of the operating company may be outsourced to an integrated freighting supply chain vendor, if said leading manufacturer is not directly responsible for delivery of the rental products to the operating company.

In terms of intra-company distribution, the operating company may employ supply chain solutions entities such as Federal Express or UPS to increase operational and logistical efficiency, and secure the meeting of product response to on-line sales, inclusive of daily supply chain delivery and returning of inventory to the rental car company site as dictated by customer demand responding to the fluctuation of site and season. As described below, web based and other orders are tracked in real time throughout the supply chain, allowing complete inventory transparency and accessibility.

The day-to-day operational aspects of the inventive method and system entail hardware 106 such as a Motorola MC70 for purposes of tracking and inventory control (see FIG. 1), and interface with a server 100 of the car rental entity, and applicable databases 102 thereof. (See FIG. 2.) The application associated with the inventive method, through reservation system 103, provides on-line access to information about all inventory, inclusive of status such as currently rented, returned, in repair or service mode, tracks reservation numbers, and views reports of usage information regarding each car seat. See FIGS. 3-6. This information is available both through a personal computer 104 and the mobile device 106 using hardware such as said Motorola MC 70. The mobile application encompasses GPRS wireless network 107 and a mobile bar code scanning capability. A unique bar code is placed upon each car seat. In the mobile application, each car seat is scanned and the status thereof updated, e.g., rented, returned, or subject to current service. The same operates to update the back end database system 108 and to update the PC application in real time. Therein, the system enjoys enhanced visibility with regard to status, and condition of any inventory and special client issues in connection therewith, tracking customer-specific profile and demographic information.

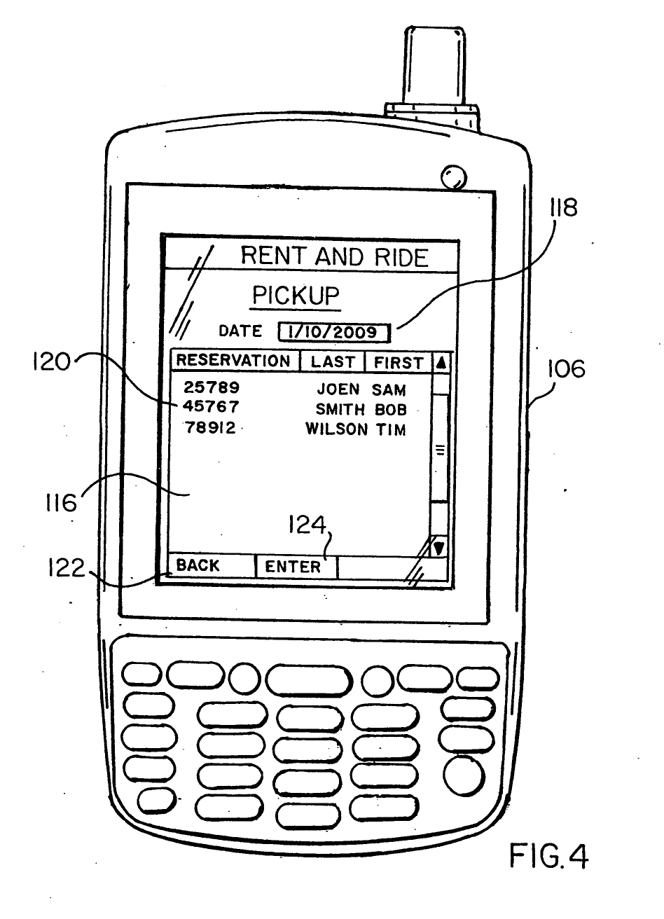

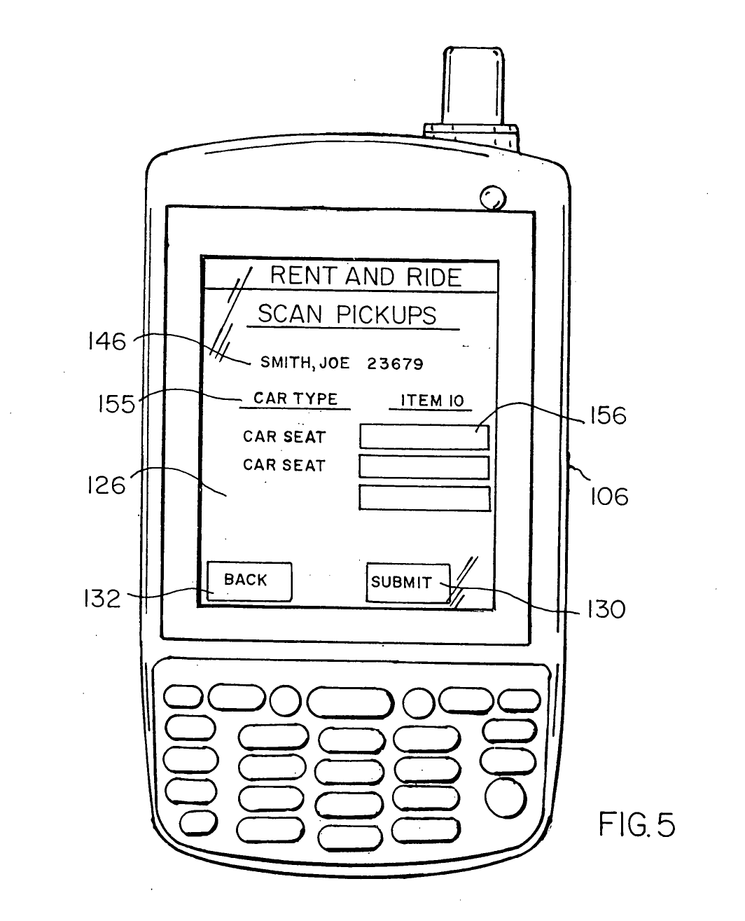

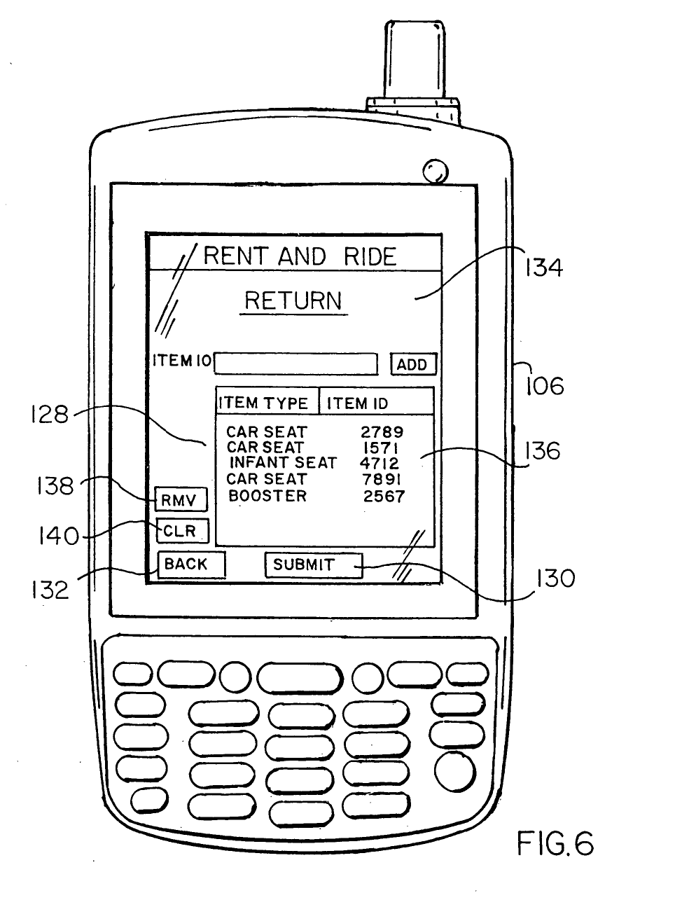

At a global level, the inventive system provides:
1. import of data from the car entity reservation system 103;
2. a menu 113 upon the mobile device 106 (see FIG. 3);
3. information upon the mobile device regarding pick-up (see FIGS. 4-5); and
4. information regarding return of the car seat, booster or the like upon return, all of which creates a data file 110. (See FIGS. 2 and 6).

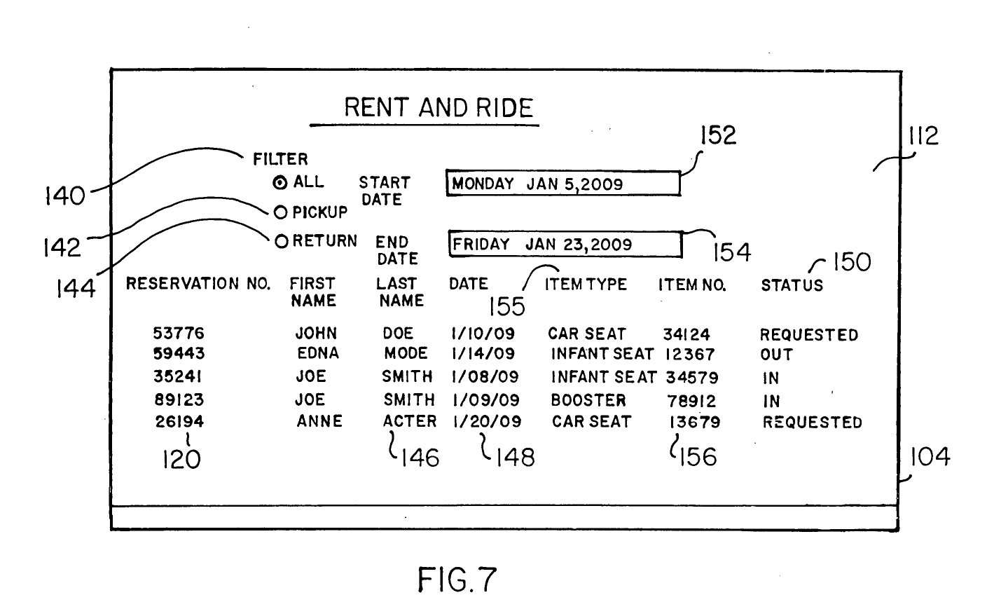

The system also filters and reviews data, and generation of reports 112, upon the PC application. See FIG. 7.

In regard to input of data from the rental car entity and reservation agents associated therewith, direct customers of the car rental company and its reservation agents enjoy the capability of making, changing and cancelling reservations within the reservation system 103 of the car rental company. Reservation related information in regard to a rented product is exported in data file 110 from the rental agency to a folder on the server 100 of the operating company. Software imports data into the operating company's database 102. See FIG. 2. Therein, the car rental company establishes triggers to immediately send such data file to operator's server 100 when a transaction occurs. These triggers apply to each and every method that leads to the creation, change, or cancellation of a reservation. The transactions which require such triggers include:

A. New reservations.
1. transaction type.
2. reservation number.
3. reservation type.
4. customer first name.
5. customer last name.
6. rental location or vehicle lot.
7. reservation date.
8. return date.
9. operation company product type where multi-line product rental occurs.
10. vehicle parking location, when known, that is, location of vehicle to be picked-up.

B. Addition of product and changes in reservation may include:
1. added product.
2. removal of product.
3. pick-up/drop off location.
4. pick-up/drop off location change.
5. reservation date/return date.
6. vehicle to be picked-up.
7. change in vehicle pick-up location.
8. cancellation of vehicle reservation.

With respect to the mobile application, a typical main menu screen 113 would be similar to that shown in FIG. 3 herewith. Thereon, the main menu defaults to the present date 114 with the user able to change dates as desired. The date is also useful as a criterion to filter upon the pick-up/return screen shown in FIGS. 3 and 4, including windows 142/144.

Upon pick-up, an operating company user would be able to choose a date 114 of pick-up as is shown in FIG. 3. Such dates are selected on the menu shown in FIG. 3. The screen of FIG. 4 is populated by all of the reservations 120 with the car seats for pick-up on the date 118 specified, which list can be sorted by reservation number 120, last name or first name. Clicking on the “back” button 122 of the hand-held device shown in FIG. 4 will take one back to the main menu. Clicking upon the “enter” button 124 takes one to the next screen 126 with details of the highlighted sections.

The appearance of the hand-held unit in regard to the pick-up detail is shown in FIG. 4. The screen displays the last name, first name and reservation 120 number at the top of the screen so that the user can identify the transaction. The screen displays all of the car seats that are linked to a particular reservation number, also showing the item type(s). The operational company user scans a bar code on each corresponding item type to initiate the pick-up detail on the hand-held unit.

Per FIG. 5, when all values have been entered, the user clicks “submit 130” and sends the information to the database 102. Clicking backward button 132 will return the preceding screen.

A sub-screen 128 of FIG. 5 provides vehicle pick-up details, including car type 155 and car seat type 156,

In regard to the return mode, shown in FIG. 6, the “return” screen 134 permits the user to scan multiple records and adds them to the list. As the user scans the identifications for each car seat, the inventory of seats populate a list 136 with the item types and identification number. When the user is finished scanning all, he clicks the “submit” button 130 to thereby send the records to the database (see FIG. 2) together with a time stamp of the transaction. At this point, clicking back takes one to the main menu. Clicking a “RMB” 138 removes a highlighted entry in the list in the event of a mistake. Clicking a “clear” button 140 will clear the entire list.

With reference to FIG. 7, there is shown PC screen 112 and applications of the above. The screen, allows a user to investigate reservations by name, reservation number 120, date ranges 152/154 and status 150. By activation of this option the user enjoys an ability to change status by clicking on a row and changing the value from the drop- down menu. Changing the filter 140 to “pick-up” 142 displays only pick-up on the list. Changing the filter to “return” 144 will display only returns on the list. All lists include applicable reservation name 146, reservation number 120, dates 148 and status 150. Changing the start and end dates operates to narrow the list to include only the dates 152/154 selected. The user is able to sort any of the columns to view the data in multiple orders.

The hardware needed in connection with the instant system is as follows:

1. Website to host the application.

2. Server/PC running IIS software 158 and storing an SQL database (see FIG. 1).

3. SQL server license if data is over 40 GB, otherwise a free version SQL Express can be used.

4. Mobile bar code scanning device such as the Motorola MC70 above described.

5. GPRS cards for the mobile devices to access the Internet including GPRS cards if the proprietary seat management unit embodiment of the invention is employed.

6. A personal computer (PC) to access the web in the current application.

As may be appreciated from the above, the present inventive method and system is responsive to the needs of travelers, airlines, airports, and other public carriers including trains, car rental companies, buses, and cruise ships for providing to the consumer convenience, efficiency, reliability and high level of hygienic standards in the rental or purchase of children's restraint devices at either the baggage area within an airport terminal, at the car rental companies inside and outside the terminal, at CONRACs, or in any nearby area where the passenger has elected to rent a car from a car leasing entity. A consumer may initiate a rental of the child's car seat or restraint through either the operating company's website, the car leasing/rental company's website, or any other third-party site or operator or the airline website that would furnish a link to the operating company's site. After a reservation is made, the above set forth operational protocols are employed.

While there has been shown and described the preferred embodiment of the car seat management system invention it is to be appreciated that the invention may be embodied otherwise than is herein specifically shown and described and that, within said embodiment, certain changes may be made in the form and arrangement of the parts without departing from the underlying ideas or principles of this invention as set forth.

I claim:

1. A method of providing a service to travelers enabling them to acquire, at their destination within a time frame set by user, one or more essential items provided by operator for sale or rent, that may be checked or carried on an aircraft or available at an alternative mode of transportation, such items may include child restraint devices required for use in cars and mobility assistance devices, the method comprising the steps of:
determining by said user essential items needed at their destination, within a time frame determined by said user, as a means for reducing the amount of checked and carry on baggage whereby avoiding or eliminating checked and carry on baggage fees and decreasing risk of loss and damage of such items in the course of transit;
describing in at least one database accessible via a network, website, telephone or at the point of service, each of the plurality of destinations to which such user can travel, each of the plurality of essential items at said destination, designating user's time frame for use of said essential items, said essential items being provided by means of spoken word, internet or point of service at said destination;
processing a rental reservation, in a computerized system said rental reservation from a consumer via interface with, airline, car rental companies, third party websites and entities such as travel agents and travel web sites, directly with operator web site or at the point of service, the essential items designated to be rented or purchased by the consumer at designated location, time and rental period;
providing a direct link with a data file in a computerized system to operator receiving and processing a transaction or reservation, comprised of information between user, airline, car rental companies, third party websites and entities such as travel agents and travel web sites, to incorporate rental or purchase of such essential items into a reservation process or providing such service at the point of service to users and travelers who have not previously initiated such link whether or not with reference to the rental of an automobile;
providing the essential items to a consumer in either a centrally located kiosk, a retail management unit, in-line space, baggage claim area, passenger terminal, car rental company within or near the airport, or in a consolidated rental car facility or CONRAC at or near the airport, or an alternative mode of transportation terminal whether or not with reference to the rental of an automobile;

2. The method as in claim 1, further comprising a step of receiving and processing payment information from the consumer at operator web site, via third party, car rental company or point of service.

3. The method as in claim 1 of generating a user profile, within said computerized system, a database including information relating to destination, time frame, and essential items previously indicated by user.

4. The method as in claim 1 of managing inventory control of essential items wherein a mobile management system with enabling software and PC based hardware enables procurement, delivery and inventory management through the use of a combination of mobile computing units which may include but not be limited to, Radio Frequency Identification chip technology using optical readers or UPC bar codes to identify and control inventory distribution, tracking and storage, monitor and manage recalled, retired and or expired inventory.

5. The method as in claim 1 of providing real time supply chain visibility, monitoring said inventory for damage, linking to manufacturer and consumer web sites for notification of recalled, retired or expired inventory and guarantying inventory availability.

6. The method as in claim 1 of implementing a sanitation and compliance protocol wherein such essential items are sanitized and inspected for compliance with federal safety standards.

7. A method as in claim 1, wherein the improvements further comprise a process for said car rental companies to outsource the rental or operation of an alternative revenue source to operator of one or more essential items which may be offered as part of car rental options as a means to reduce overhead including labor and inventory.

8. The method as in claim 1 whereby such rental car companies may monitor parameters of interest inclusive of reservation numbers, cancelations, modifications in reservation and pick up and drop off location and time, returns, inventory availability, financial transactions and consumer usage patterns.

9. The method as in claim 1, whereby providing airlines, airports or alternative venues a means for alternative revenue sources, additional concession revenue and an increase in passenger service.

10. The method as in claim 1, providing essential items which are inconvenient, bulky, restricted as checked baggage, seasonal, physically or logistically difficult to transport to a consumer in either a centrally located kiosk, a Retail Management Unit, in-line space, baggage claim area, passenger terminal, or in a Consolidated Rental Car Facility or CONRAC at or near the airport, or an alternative mode of transportation terminal whether or not with reference to the rental of an automobile.

11. The method as in claim 1, enhancing compliance with legal requirements in area of children's restraint devices, availability of medically necessary equipment and mobility devices.

12. The method as in claim 1, further comprising a step of reducing environmentally adverse levels of carbon emissions, baggage area congestion, the incidence of lost or damaged checked baggage and resulting liability, airline turnaround time, providing a system by which a more cost-effective use of CONRAC and rental car areas, both inside and outside airports may be affected.
